(19) United States
(12) Patent Application Publication
(10) Pub. No.: US 2011/0030055 A1
(43) Pub. Date: Feb. 3, 2011

(54) Detecting Spoofing in Wireless Digital Networks

(76) Inventors: Rajini Balay, Fremont, CA (US); Kal Prabhakar, San Jose, CA (US); Gopalakrishnan Raman, Santa Clara, CA (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/533,924

(22) Filed: Jul. 31, 2009

(51) Int. Cl. G06F 11/00

(52) U.S. Cl. 726/22

(57) ABSTRACT

Detecting spoofing in a digital network. Packets of information in a digital network using a shared medium contain a unique identifier for the device originating the packet. An individual device may be transmitting, or receiving, but not both. If a device receives a packet containing its unique identifier as the origin address, that packet must have been transmitted by another device, and a spoofing alert is raised.

### BACKGROUND OF THE INVENTION

The present invention relates to wireless digital networks, and in particular, to the problem of detecting spoofing in wireless digital networks.

Wireless digital networks, such as those operating to IEEE 802.11 standards, broadly comprise wireless clients communicating with wireless access points on a shared medium, which in turn communicate with one or more controllers providing access to services and the Internet.

As is common in the development of technology, systems designed for one use can be and often are misappropriated for other uses. Wireless digital networks can be attacked, usurped, and misused. Various measures are used in such networks to detect misuse, and to detect intrusion by malicious devices.

In seeking to disrupt or infiltrate a network, an attacker or malicious device may seek to spoof, or impersonate, legitimate devices in the network. A device may spoof an access point, for example, in an attempt to get clients to divulge sensitive information. A malicious device may spoof a client device. Or, a malicious device may replay old information captured from the network, spoofing many devices. In digital networks such as Bluetooth, Zigbee, or IEEE 802.11 networks, each wireless device has a unique media Access Controller (MAC) address, which is used in communicating with other devices. In one method of spoofing, a malicious device uses on the MAC address of another, valid device.

A method known to the art of detecting MAC address spoofing is to monitor the sequence number found in the header of all IEEE 802.11 wireless frames. For each MAC address monitored, this sequence number should increase in a predictable, linear fashion. A deviation from such monotonic increase is a sequence number anomaly, which may indicate the MAC address in question is being spoofed. Unfortunately, as is known to the art, this approach is prone to error.

What is needed is a way of detecting spoofing in wireless digital networks.

### BRIEF DESCRIPTION OF THE DRAWINGS

The invention may be best understood by referring to the following description and accompanying drawings that are used to illustrate embodiments of the invention in which:

FIG. 1 shows a network, and

FIG. 2 shows a 802.11 frame.

### DETAILED DESCRIPTION

Embodiments of the invention relate to methods of detecting spoofing in wireless digital networks.

In many wireless digital networks, such as TCP/IP networks, each packet transmitted by a station contains that station's unique Media Access Control (MAC) address in a field indicating that it is the source of the packet. In many wireless digital networks, such as an IEEE 802.11 wireless digital network, a station is either transmitting or receiving on a shared medium. If a station is transmitting, it is not receiving, and if it is receiving, it is not transmitting. If a station receives a packet containing its own MAC address as the source address, that packet must have been sent by another device, which therefore must be spoofing.

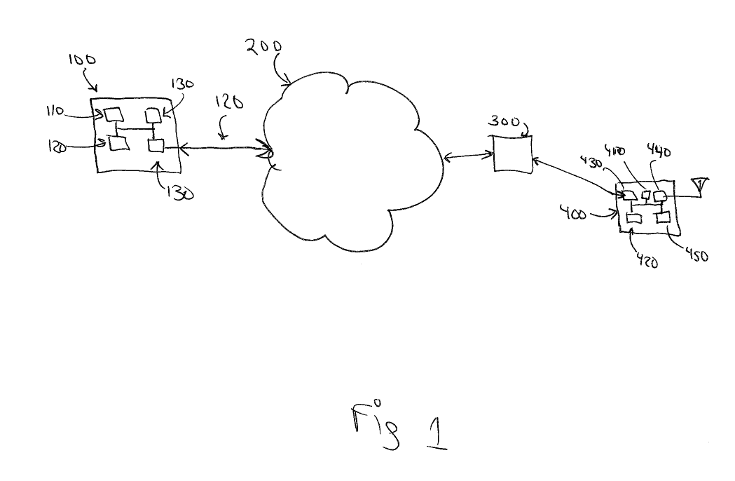

FIG. 1 shows a digital network. Controller 100 connects 120 to a switched network 200 such as the Internet. At a remote location, interface 300 also connects 320 to network 200 providing connectivity 350. Interface 300 may be a device known to the art such as a DSL or Cable modem, or a wireless interface such as a 3G, WiMAX, WiFi, or other radio connection. Interface 300 provides services such as Internet access via wired connection 350, which may be in the form of an IEEE802.3 Ethernet interface, or another wired interface such as USB or IEEE1394 Firewire. Access point 400 connects 350 to the Internet via first wired interface 430.

Controller 100 is a purpose-built digital device having a CPU 110, memory hierarchy 120, and a plurality of network interfaces 130. CPU 110 may be a MIPS-class processor from companies such as Raza Microelectronics or Cavium Networks, although CPUs from companies such as Intel, AMD, IBM, Freescale, or the like may also be used. Memory hierarchy 120 includes read-only memory for device startup and initialization, high-speed read-write memory such as DRAM for containing programs and data during operation, and bulk memory such as hard disk or compact flash for permanent file storage of programs and data. Network interfaces 130 are typically IEEE 802.3 Ethernet interfaces to copper, although high-speed optical fiber interfaces may also be used. Controller 100 typically operates under the control of purpose-built embedded software, typically running under a Linux operating system, or an operating system for embedded devices such as VXWorks. Controller 100 may have dedicated hardware for encryption, and/or for routing packets between network interfaces 130. Controller 100 may also be equipped with Trusted Platform Module (TPM) 160, an industry-standard device for providing secure storage.

Access point 400 is also a purpose-built digital device having a CPU 410, memory hierarchy 420, a first wired interface 430, an optional wireless interface 440, second wired interface 450 which may represent a plurality of additional wired interfaces, and may contain TPM 460 for secure storage. As with controller 100, the CPU commonly used for such access nodes is a MIPS-class CPU such as one from Raza Microelectronics or Cavium Networks, although processors from other vendors such as Intel, AMD, Freescale, and IBM may be used. Memory hierarchy 420 comprises read-only storage such as ROM or EEPROM for device startup and initialization, fast read-write storage such as DRAM for holding operating programs and data, and permanent bulk file storage such as compact flash memory. Access point 400 typically operates under control of purpose-built programs running on an embedded operating system such as Linux or VXWorks. Optional wireless interface 340 is typically an interface operating to the family of IEEE 802.11 standards including but not limited to 802.11a, b, g, and/or n. First wired interface 430 may be an IEEE803.2 Ethernet interface, or other wired interface such as USB or IEEE1394 Firewire. Similarly, second wired interface 450 may be one or more IEEE802.3 Ethernet interfaces, USB interfaces, IEEE1493 Firewire interfaces, or a combination. As an example, a small remote access point 400 may have an IEEE803.2 Ethernet wired interface for first wired interface 430, an IEEE802.11a/b/g/n wireless interface 440, and an additional IEEE802.3 Ethernet port and a USB port as second wired interface 450. A larger access point 400 may have multiple second Ethernet ports.

While the invention is described in terms of IEEE802.11 wireless protocols, aspects are equally applicable to other wireless network protocols such as Bluetooth, Zigbee, and others where individual device addresses are used in operation on a shared medium.

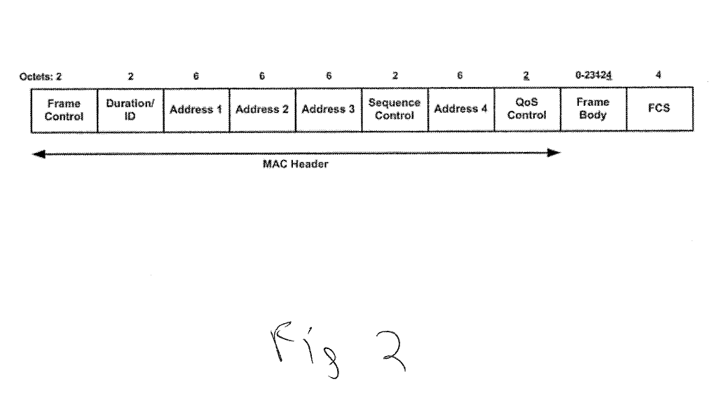

According to an aspect of the invention, an access point such as access point 400 supports traffic to and from clients using wireless interface 440. According to IEEE 802.11 standards, transmitted wireless frames include the MAC address of the device transmitting the frame. An example of such a frame is shown in FIG. 2, and is described in more detail, for example, in Part 11 of IEEE Standard 802.11-2007, Wireless LAN Medium Access Control (MAC) and Physical Layer (PHY) Specifications, incorporated herein by reference. Depending on the frame type, the fields shown as Address 1, Address 2, and Address 3 in FIG. 2 contain the MAC address of the destination device, and the MAC address of the transmitting device.

In such devices, if the transmitter is operating, the receiver is not, and if the receiver is operating the transmitter is not. Access point 400 monitors all frames it receives. If it receives a frame containing its own MAC address, it signals an error, indicating that some device is spoofing its MAC address. Optionally, access point 400 may capture the frame containing the spoofing attempt, or the entire packet of which the frame is a part.

Access point 400 may signal this error to its controller 100. The nature of this signaling may vary depending in information available. Access point 400 may simply signal a spoofing event. Controller 100 has the information on the channel access point 400 is operating on, and time. Or, access point 400 may signal a spoofing event with increased detail, such as relaying the captured frame or packet contents or receive characteristics, such as signal strength, rate etc, and more accurate time stamps.

It is known in the wireless arts to use an access point for scanning other channels. As an example, access point 400 operating on channel 6 in the 2.4 GHz band may sweep all 2.4 GHz band channels with its receiver during idle periods when it is not handling traffic, or as directed by its controller 100. If during such a sweep, access point 400 receives a frame or packet containing its MAC address, it has detected a spoofing event, which it signals back to its controller 100.

The invention may also be practiced in wireless devices other than access points. The software for handling the wireless receiver, such as the device driver or the low-level portions of the wireless networking stack may be adapted to detect when the device receives frames or packets containing the device's MAC address, and signal an error indicating a spoofing event has been detected.

The present invention may be realized in hardware, software, or a combination of hardware and software. The present invention may be realized in a centralized fashion in one computer system, or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A method of detecting spoofing in a wireless network comprising:
receiving frames at a wireless device in the network,
comparing the unique identifier in the source field of the received frame with the unique identifier for the wireless device, and
signaling an event that spoofing has been detected if a source field in the received frame contains the unique identifier for the wireless device.

2. The method of claim 1 where the unique identifier is a MAC address.

3. The method of claim 1 where the frame is an IEEE 802.11 frame.

4. The method of claim 1 where the step of signaling includes sending one or more of: the time the frame was received, frame contents, received characteristics.

5. A method of detecting spoofing in a wireless network having a plurality of wireless access points hosted by a controller, the access points using a shared medium where each access point has a unique identifier which is transmitted in a source field of each frame, the method comprising:
receiving frames at an access point,
comparing the unique identifier in the source field of the received frame with the unique identifier for the access point, and
signaling an event that spoofing has been detected if a source field in the received frame contains the unique identifier for the access point.

6. The method of claim 5 where the unique identifier is a MAC address.

7. The method of claim 5 where the frame is an IEEE 802.11 frame.

8. The method of claim 5 where the step of signaling includes sending to the controller one or more of: time the frame was received, frame contents, received characteristics.

9. The method of claim 5 wherein the steps of claim 5 are performed by at least one machine in accordance with at least one computer program stored in a computer readable medium, said computer program having a plurality of code sections that are executable by the at least one machine.

10. Software for detecting spoofing in a wireless digital network comprising:
a comparator configured to compare the source address field in received wireless frames with the address of the receiving device, wherein the comparator signals when the source address field in a received wireless frame is the same as the address of the receiving device, and
a message generator for generating a message when the comparator signals that the source address field in a received wireless frame is the same as the address of the receiving device, wherein the comparator and the message generator are software digitally encoded in a computer readable medium executable by a computing device, which causes the computing device to perform a set of actions for which the comparator and the message generator are configured.
